(19) United States
(12) Patent Application Publication
(10) Pub. No.: US 2025/0335896 A1
(43) Pub. Date: Oct. 30, 2025

(54) INTEGRATED CRYPTOCURRENCY-BASED PAYMENT SYSTEMS AND METHODS

(71) Applicant: PDX GLOBAL PTE. LTD., Singapore (SG)

(72) Inventor: Shane X.G. Rodgers, New York City, NY (US)

(21) Appl. No.: 19/186,537

(22) Filed: Apr. 22, 2025

Related U.S. Application Data
(60) Provisional application No. 63/638,056, filed on Apr. 24, 2024.

(51) Int. Cl. G06Q 20/32; G06Q 20/06; G06Q 20/20; G06Q 20/38; G06Q 20/40

(52) U.S. Cl. CPC G06Q 20/3223; G06Q 20/065; G06Q 20/20; G06Q 20/389; G06Q 20/4014; G06Q 20/4016; G06Q 20/407; G06Q 2220/00

(57) ABSTRACT

Approaches disclosed herein provide digital payment processing that integrates cryptocurrency transactions with traditional banking systems through the use of, for example, blockchain technology in a streamlined digital payment process. As an example, a digital payment processing system may integrate cryptocurrency with exchanges and banking systems via APIs. Such integration allows for the determination and use of real-time exchange rates, as well as almost immediate transfer of funds between cryptocurrency and fiat (traditional) or other such currency. By automating the exchange process and connecting directly to financial institutions for instant fiat settlement, such approaches can effectively avoid the usual delays of blockchain (or other distributed ledger-based) confirmations. Such a system may also utilize other technologies for facilitating a faster transaction process, such as off-chain solutions or layer-2 scaling solutions.

### CROSS-REFERENCE TO RELATED APPLICATION(S)

This is a U.S. non-provisional patent application that is related to and that claims the benefit of priority from U.S. provisional patent application Ser. No. 63/638,056, filed on Apr. 24, 2024, and entitled “INTEGRATED CRYPTOCURRENCY-BASED PAYMENT SYSTEMS AND METHODS,” the entire contents of which is incorporated by reference herein and form a part of this specification for all intents and purposes.

### TECHNICAL FIELD

This disclosure relates to completing commercial transactions with cryptocurrency.

### BACKGROUND

In today's world, transactions are predominantly managed digitally and are facilitated by a network of banking systems and electronic payment services. Traditional fiat currencies, e.g., the United States dollar (USD), are government-issued, and they remain the foundation of everyday commerce. In recent years, the emergence of cryptocurrency has impacted the way in which various entities approach financial transactions. Unlike fiat currencies, cryptocurrencies operate on decentralized platforms using distributed ledger technology, such as a blockchain, which serves as a public financial transaction database. However, the integration of cryptocurrency into mainstream commerce has been slow and has faced resistance. This is partly due to the complexities associated with digital currencies and the lack of instant settlement capabilities that consumers and businesses have come to expect from traditional financial transactions. In existing cryptocurrency systems, transactions typically require blockchain-type confirmations that can introduce delays, which is not conducive to the pace of contemporary commerce that demands immediacy. As a result, there remains a significant barrier to the broad adoption of cryptocurrencies for everyday transactions.

### BRIEF DESCRIPTION OF THE DRAWINGS

Various embodiments in accordance with the present disclosure will be described with reference to the drawings, in which:

FIG. 1 illustrates a system for performing a commercial transaction with cryptocurrency and fiat currency, according to example embodiments;

FIG. 2 illustrates a system for performing a commercial transaction with cryptocurrency and fiat currency, according to example embodiments;

FIG. 3 illustrates a process for collecting funds from a user and transmitting those funds to a merchant to settle a commercial transaction, according to example embodiments;

FIG. 4A illustrates a conventional system for performing a commercial transaction, according to example embodiments;

FIG. 4B illustrates a system for performing commercial transactions using the present embodiments, according to example embodiments;

FIG. 5A illustrates a system and process for completing a commercial transaction via a cryptocurrency broker, according to example embodiments;

FIG. 5B illustrates a graphical user interface for selecting a cryptocurrency coin for completing a commercial transaction, according to example embodiments;

FIG. 6A illustrates a process for completing a commercial transaction using cryptocurrency and fiat currency, according to example embodiments;

FIG. 6B illustrates a process for completing a refund of a commercial transaction using cryptocurrency and fiat currency, according to example embodiments;

FIG. 7A illustrates a process for completing a commercial transaction using cryptocurrency and fiat currency, according to example embodiments;

FIG. 7B illustrates a process for submitting a transfer of fiat currency to a settlement bank, according to example embodiments; and

FIG. 8 illustrates a computing system for performing transaction request, according to example embodiments.

### DETAILED DESCRIPTION

A unique cryptocurrency wallet address is made for each transaction to enhance user privacy and security by limiting attach surface (i.e., it spreads out your transactions per wallet). These temporary wallet addresses may be disposed of after the fact. This also reduces traceability across multiple transactions.

The present disclosure is directed to a system for completing digital transactions using cryptocurrency and fiat currency. In contrast with conventional fiat currency systems—which rely on various intermediaries such as payment processors, card associations, and acquiring banks—the present systems rely on far less intermediary steps by, at the very least, converting fiat currency into cryptocurrency to complete a transaction.

In an example embodiment, a user may initiate a transaction at a point of service (POS) terminal, e.g., a digital cash register or checkout terminal, by scanning one or more items at the POS terminal. The POS terminal may be associated with a merchant, e.g., a grocery store. Upon scanning the items, the POS terminal may generate a payment request, the payment request prompting the user to pay for the scanned goods. The payment total may be displayed as fiat currency, e.g., $50.00 USD. In some example embodiments, the POS terminal may display a quick response (QR) code designed to be scanned by a camera on the user device associated with the user, the user device including any smart device, e.g., a smart phone, tablet, or other camera-enabled device. The user device may scan the QR code and, based on the information received from the QR code, open a software application or website for continuing the transaction. Once on the software application or website, the user may confirm the transaction amount (in fiat currency, e.g., USD) and select one of any number of cryptocurrencies with which the user would like to complete the transaction. In example embodiments, the user may already have an amount of fiat currency in a payment account, e.g., $1,000.00 USD. Since the payment being requested is $50.00 USD, the user may be prompted by the software application to convert $50.00 USD into a selected cryptocurrency, e.g., Bitcoin. The user may also be prompted with any number of cryptocurrencies with real-time exchange rates. Once the user selects a cryptocurrency, the application may generate a unique cryptocurrency wallet address for the transaction (and for every transaction performed in the embodiments discussed herein). The wallet address containing the cryptocurrency to complete the equivalent of the purchase total is sent to a cryptocurrency broker. Once the fiat currency has been converted into cryptocurrency, a settlement entity (e.g., a settlement bank) may be notified of the conversion as well as other identifying information regarding the transaction such as a merchant ID, user ID, transaction amount, and transaction itemization. With this information, the settlement bank may immediately transfer an equivalent fiat currency amount to the merchant (or associated merchant bank, merchant account, etc.) to satisfy the transaction request. The settlement bank may transfer this equivalent fiat currency amount from an existing surplus of fiat currency, i.e., the settlement bank does not have to wait for the cryptocurrency broker to convert the cryptocurrency into fiat currency before completing the transaction request. This ensures that the transaction request is completely immediately. Meanwhile, the cryptocurrency broker may sell the cryptocurrency to convert it back into fiat currency. Once this converted fiat currency has been acquired, the cryptocurrency broker may send the converted fiat currency to the settlement bank to replenish the fiat currency that was sent to satisfy the transaction request.

These systems provide improvements over conventional financial and transaction processing systems by significantly reducing the time and latency associated with commercial transactions. Some traditional card-based payment processing systems involved multiple intermediaries, including issuing banks, card network's payment gateways, and acquiring banks, each introducing its own delay and verification process. By contrast, the disclosed system eliminates multiple handshakes by allowing the user to convert cryptocurrency into fiat currency at the point of sale through a single, streamlined software application. The application advances the fiat currency to the merchant from a settlement entity (e.g., a settlement bank), thereby enabling near-instantaneous transaction completion from the user's perspective, while offloading the conversion delay to the blockchain backend. This front-loaded liquidity model reduces end-to-end transaction latency and improves the responsiveness of real-time payment systems.

This disclosure also provides enhanced security and technical improvement through the use of transaction-specific cryptocurrency wallets and blockchain-based ledgering. Rather than rely on centralized storage of payment credentials or static tokens, which are susceptible to fraud, the system generates ephemeral wallets that are cryptographically unique to every transaction.

Furthermore, the architecture optimizes computational and networking efficiency by localizing the heaviest computation—cryptocurrency conversion and settlement—at the broker and cloud platform level, away from the user device. Thus, the system reduces bandwidth consumption and processing overhead on both merchant and user devices.

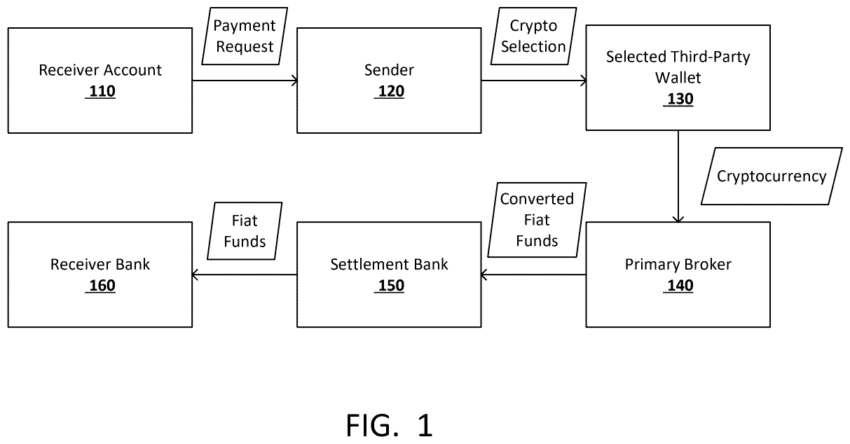

FIG. 1 illustrates a streamlined cryptocurrency transaction process according to an example embodiment. The illustrated transaction process may be performed by a digital payment processing system or service, among other such options.

A receiver account 110 may be associated with an entity that is entitled to payment from a sender, including traditional merchants, various service providers, landlords, or any entity involved in commercial transactions. The receiver account 110, through integration with modern point-of-sale systems like Sweet Retail and Clover, can generate a payment request (or enable a customer to generate a payment request) via a quick response (QR) code or other such mechanism. The QR code may be associated with a unique payment link for completing a transaction. The QR code generated by the receiver account 110 may encode information that may be used to direct a sender to a location (e.g., a URL or API) from which the sender can obtain all the necessary transaction details and provide a gateway for payment initiation. As a nonlimiting example, a receiver associated with the receiver account 110 may represent any entity entitled to receive funds, such as retailers, hotels, service businesses, or individuals.

A sender 120 may scan the provided QR code and may be directed to a payment link, which, when accessed, may guide the sender 120 through a payment process involving cryptocurrency. The sender 120 may be associated with a user device such as a camera-enabled device, scanner-enabled device, or other smart device including, without limitation, a smart phone, tablet, laptop, personal assistant device, smart watch, or other wearable device. In example embodiments, the receiver associated with the receiver account 110 may download a software application or access a web page provided by a digital payment processing system. Through this software application or web page, the receiver associated with the receiver account 110 is allowed to register an account with the digital payment processing system (if one does not already exist). If the receiver has not already registered an account with the digital payment processing system, then during the registration process, the receiver's identity (which may correspond, e.g., to a business certificate) may be validated. Through this mobile application and/or web page, the receiver associated with the receiver account 110 may be able to initiate a payment request directed to a sender 120.

The sender 120 may be a party responsible for making a payment. By scanning the QR code generated by the receiver account 110, the sender 120 may initiate or activate a payment process which is guided by, e.g., an application interface or user interface between a user device and the application associated with the payment process. In example embodiments, the payment process may occur through a dedicated customer application, for example, as may be available on mobile platforms such as iOS and Android, which can lead the sender through the selection of cryptocurrency from a third-party crypto wallet 130 of their choice. As a nonlimiting example, the sender may register an account with a digital payment processing system or service through the software application. During the registration process, the sender's identity may be verified. The sender may then select the cryptocurrency to be used, which can be linked to their third-party crypto wallets 130.

Upon selecting a desired cryptocurrency, the digital payment processing system may check for sufficient wallet balance to cover the transaction and any associated fees. If the balance is adequate, the transaction may proceed using with a primary broker 140, such as, e.g., Kraken, which collects and liquidates the cryptocurrency into fiat currency such as, e.g., USD. In other example embodiments, the cryptocurrency may be first transferred from the selected third-party cryptocurrency wallet 130 to a cryptocurrency wallet managed by the digital payment processing system or service, where the cryptocurrency wallet is associated with the sender's account registered with the digital payment service. In one embodiment, if the balance associated with the desired cryptocurrency is not sufficient for making the payment, the digital payment processing system may prompt the sender to select another cryptocurrency for making the payment. When the digital payment processing system determines that there is sufficient balance for making the payment, specifications associated with the selected crypto coins are sent to a primary broker 140 for further processing.

A primary broker 140 such as, e.g., Kraken may receive a request and manage the liquidity of the cryptocurrencies selected by the user associated with the sender 120 into fiat currency. A primary broker 140 may represent a cryptocurrency exchange platform such as Kraken. The primary broker 140 may function as an intermediary that sells assets such as various cryptocurrencies from the selected third-party cryptocurrency wallets 130. Usually, selling cryptocurrencies and collecting the equivalent fiat (or other such) currency may result in a delay ranging from several minutes to several days. Such a delay makes it challenging for customers to use cryptocurrency as a digital payment. However, digital payment processing approaches as presented herein provide a solution to such an issue, at least partly because of the involvement of a settlement bank 150 in the streamlined payment process. While the primary broker 140 is processing the request of selling the cryptocurrencies, the settlement bank 150 may fund the receiver bank 160 with the requested amount. Upon confirming with the settlement bank that a settlement payment is made, a confirmation of payment from the receiver bank 160 is generated and sent to the receiver associated with the receiver account 110. Such a process can be conducted in a relatively short period of time compared to conventional fiat currencies exchange or even conventional cryptocurrency exchanges discussed herein, such that the customer and/or merchant will not be impacted by (or potentially even aware of) any delay. At the same time, the settlement bank 150 may be waiting for the primary broker 140 to liquidate the cryptocurrency, and when a corresponding fund from the primary broker 140 is received by the settlement bank 150, the transaction process is fully complete.

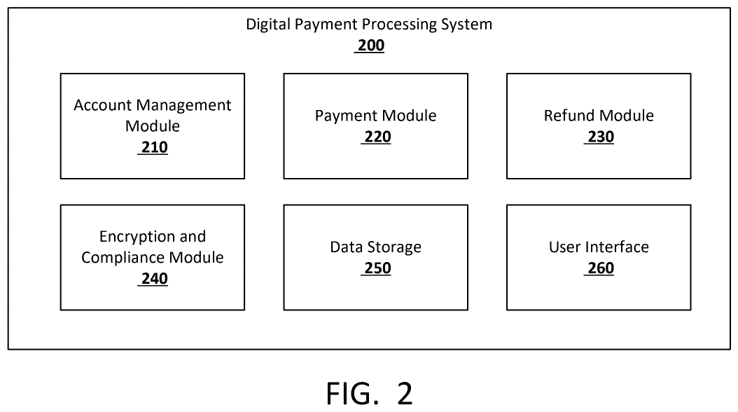

FIG. 2 illustrates a block diagram including several modules, each serving a function within an example digital payment processing system 200 according to at least one embodiment. It should be understood that there may be additional, fewer, or alternative modules, devices, services, or components used in other systems, services, or offerings as well within the scope of various embodiments. As used in the present disclosure, a module includes both hardware and instructions. The hardware can include one or more processors, one or more microprocessors, one or more microcontrollers, one or more microchips, one or more application-specific integrated circuits (ASICs), one or more field programmable gate arrays (FPGAs), one or more graphical processing units (GPUs), one or more tensor processing units (TPUs), and/or one or more devices and/or components of any other type deemed suitable by those of skill in the art for a given implementation. In some cases, a module includes at least one functional component (e.g., an application or part of an application, a block of code, and/or the like) executing in whole or in part on one or more processors of a host system or device.

In FIG. 2, a digital payment processing system 200 may include an account management module 210 which manages user accounts within the digital payment processing system 200, a payment module 220 which manages transactions, a refund module 230 which handles refund requests, an encryption and compliance module 240 which provides security and legal compliance, a data storage 250 which manages transaction records, user data, audit logs, and other relevant information, and a user interface 260 which provides the visual and interactive components with which users may engage.

An account management module 210 can be responsible for tasks such as managing user accounts within the digital payment processing system 200. Generally, the digital payment processing system 200 may support user accounts which associate one or more users with a cryptocurrency wallets and payment methods. The account management module 210 may facilitate operations such as user registration, authentication, profile management, and the secure handling of user credentials and payment settings. The account management module 210 may interact with other modules to ensure that user information is up-to-date and synchronize user account activities across the platform. The account management module 210 may manage both merchant and customer accounts (e.g., receiver and sender accounts). A merchant account may provide tools for merchants to create their accounts, manage payment preferences, view transaction histories, and receive payments. Merchants may also be able to set up their catalog of products or services and configure their specific payment terms. Each account may be equipped with necessary features such as transaction management, refund initiation, and financial reporting. In example embodiments, the account management module 210 may support multiple user roles within a merchant organization which provides granular access control to sensitive financial operations.

Similarly, the account management module 210 may manage customer accounts for end-users of the digital payment processing system. A customer account may offer a streamlined process for account creation, wallet integration, and payment instrument management. Customers may be provided with intuitive tools to review past transactions, manage cryptocurrencies, and interface with the payment module 220 for initiating and tracking payments. The account management module 210 may also manage customer accounts through which customers can manage their personal and payment information. The account management module 210 may support wallet connectivity which allows customers to link their cryptocurrency wallets for efficient transaction processing. In one embodiment, both merchants and customers are required to undergo KYC (know your customer) and KYB (know your business) verification processes, respectively. The account management module 210 may integrate with third-party services to validate identities and business credentials, ensuring compliance with regulatory requirements and reducing the risk of fraud.

A payment module 220 may manage payment requests, execute transactions, and manage the flow of funds between parties. Such a payment module 220 may interface with external banking systems and cryptocurrency networks to facilitate fiat and crypto transactions, respectively, to ensure seamless and secure processing of payments. In one embodiment, a payment process using cryptocurrencies is illustrated in accordance with FIG. 1.

A payment module 220 may accept payment instructions from both merchant and customer accounts, as well as accounts for other relevant parties. A payment module 220 may process these requests, verify the transaction details and execute fund transfers in real-time with minimized delay. The payment module 220 may support a broad spectrum of transaction types, including but not limited to one-time payments, recurring billing, and batch transactions for larger merchant operations. In one embodiment, payments are processed in real-time through the utilization of Polygon's blockchain technology to minimize latency. To achieve this, the payment module 220 may convert cryptocurrency to fiat currency through the API integration with primary brokers such as Kraken exchange, banking systems, and other entities. The payment module 220 may employ various APIs to connect the digital payment processing system to various entities, including cryptocurrency exchanges like Kraken, banking systems, third-party cryptocurrency wallets, etc. Such integration allows for real-time price feeds, the execution of trade orders, the instant conversion of cryptocurrencies to fiat, and vice versa. For example, the payment module 220 may communicate with traditional banking systems through APIs that conform to financial industry standards for data transmission and security. The APIs may facilitate the transfer of funds to and from banking institutions, manage account balances, and confirm transaction completion.

In one embodiment, a payment module 220 may facilitate a peer-to-peer transaction workflow that operates independently of traditional Point of Sale (POS) systems. For example, a merchant user may select a product or service, and a payment module 220 may generate an itemized payment request within a digital payment processing system. The merchant user may either create a detailed payment request or directly input the receivable amount. The itemized payment request allows the merchant user to select specific products and services from their catalog, which is then presented in a detailed list format. This list may include essential information such as the description, quantity, and price of each item or service, providing a clear breakdown of costs for both the merchant and the customer. Such an itemized request may enable customers to understand exactly what they are paying for and ensure that merchants can account for every product or service. Once the merchant has selected the products or services and a digital payment processing system has compiled the itemized list, a payment request may be generated. Such a request may encapsulate details of the transaction, including the total amount due. Based on the request, a QR code may be generated that embodies the transaction details encrypted within it. A payment sender may scan the QR code which prompts the sender to authorize payment from the sender's crypto wallet.

In one embodiment, through a streamlined process, the payment module 220 may allow merchants to receive immediate settlement in fiat currency. The payment module 220 may utilize off-chain solutions, which handle transactions outside of the blockchain. This means that instead of each transaction being recorded on the public ledger, they are settled between parties independently, and only the final state is recorded on-chain. This significantly reduces the time needed, as the majority of confirmations are no longer required. In one embodiment, the payment module 220 may employ consensus mechanisms for faster confirmations. As used herein, consensus mechanisms may refer to the protocols used to agree on the validity of transactions. By using mechanisms that allow for faster confirmations, like Proof of Stake (POS), Delegated Proof of Stake (DPOS), or others that require less computational work than Proof of Work, transactions can be confirmed more quickly without compromising the security of the network. In one embodiment, the payment module 220 may utilize smart contracts to automate and enforce complex financial agreements, which ensures transparency and reduces the need for intermediaries.

A refund module 230 may manage the refunding or the reversal of transactions when necessary. The refund module 230 may handle requests for refunds, calculate the appropriate refund amounts, process the return of funds, and update the transaction records accordingly. The refund module 230 may initiate a refund process when a user or merchant selects an existing transaction from their respective interfaces within the digital payment processing system 200. Upon this selection, the user may request a refund, which triggers a series of automated and interactive processes. The refund process begins with the user's request via a user interface on a mobile application/web page. For a transaction to be eligible for refund, the refund module 230 may identify the transaction within the system's database as a completed and settled transaction. Upon receiving a refund request, the refund module 230 may generate a notification for the digital payment processing system to initiate the refund process protocol. The transaction in question may then be relayed to the merchant for approval. The merchant can review the transaction details, including the reason for refund and the transaction amount. If the merchant approves the refund, they select the transaction for reversal. The refund module 230 then notifies the merchant about the amount impacted by the refund. This amount is recorded in the merchant's audit log and is adjusted with the next transaction executed by the merchant. The refund module 230 may then calculate the correct refund amount. The total refunded does not include any processing fees such as gas fees for cryptocurrency transactions. Once the refund amount is calculated and approved, the digital payment processing system may receive a notification, and the corresponding bank is alerted to process the refund. The bank processes the refund amount in the fiat currency, and the funds are returned to the user's account. This process may vary by region due to different settlement bank protocols. In one embodiment, the digital payment processing system is responsible for any Additional Service Charge (ASC) that may apply to the refund transaction. This charge is presumably a system-imposed fee to cover the cost of processing the refund. Although the refund process aims for immediacy, the refund module 230 also includes the capability to handle refund transactions in batches. In one embodiment, while the initiation and approval of a refund are immediate, the actual return of funds may be processed in groups for efficiency. Following the successful processing of a refund, the refund module 230 may update all associated transaction records to reflect the reversal. This update includes the transaction's status, the final refunded amount, and any associated fees or adjustments.

An encryption and compliance module 240 may provide security and legal compliance for the digital payment processing system 200. The encryption and compliance module 240 may implement end-to-end encryption protocols for data in transit and at rest. Additionally, the encryption and compliance module 240 may enforce regulatory compliance standards related to financial transactions, data protection, and anti-money laundering (AML) requirements. The encryption and compliance module 240 may also ensure that compliance is built into the transaction workflow, with regular updates to reflect changes in the regulatory landscape. The encryption and compliance module 240 may implement state-of-the-art encryption protocols such as TLS (Transport Layer Security) for data in transit between the client and server to prevent data interception and tampering. Advanced Encryption Standard (AES) with 256-bit keys may be used for encrypting data at rest to ensure that stored data is inaccessible to unauthorized users. The encryption and compliance module 240 may include Perfect Forward Secrecy (PFS) ensuring that the compromise of a single encryption key will not compromise past communication sessions. Data masking and tokenization techniques are utilized to protect sensitive information, such as account numbers, to prevent exposure even if data access controls are bypassed. The encryption and compliance module 240 may continuously monitor transactions for compliance with international financial regulations such as the Bank Secrecy Act (BSA), the USA PATRIOT Act, and the General Data Protection Regulation (GDPR) for European users. The encryption and compliance module 240 may integrate with global watchlist databases and sanctions lists to screen transactions against known fraudulent entities and prevent illicit activities. In one embodiment, the encryption and compliance module 240 may incorporate algorithms designed to detect patterns indicative of money laundering, such as unusual transaction sizes or frequencies. In one embodiment, the encryption and compliance module 240 is designed with a flexible rule engine that can be updated in response to changes in the regulatory landscape without requiring system downtime or significant redevelopment. The encryption and compliance module 240 may utilize smart contracts on blockchain platforms, where applicable, to automate compliance with contractual and legal obligations.

The data storage 250 may be the data repository for the digital payment processing system 200. The data storage 250 may securely store transaction records, user data, audit logs, and other relevant information. The data storage 250 may employ blockchain technology to create an immutable ledger for transaction records. Each transaction is verified and then added as a new block to the chain, which is timestamped and linked to the previous block. This chain of blocks forms a secure database of records that is resistant to tampering and revision, ensuring the integrity of stored data. Rather than relying on a central point of storage, which could be a single point of failure, data storage 250 may distribute its data across a network of nodes. This decentralized approach may enhance data availability and resilience against attacks or outages. By leveraging decentralized storage systems, such as IPFS (InterPlanetary File System) or decentralized cloud storage services, the digital payment processing system may ensure data availability even in the event of a node failure. For personal and sensitive user data, the blockchain may store hashes or encrypted references to the data, rather than the data itself, to maintain privacy. Access to the actual data is controlled through cryptographic keys, which ensure that only authorized users can view or process the data. In one embodiment, audit logs are maintained on the blockchain, which provides an unalterable trail of actions that can be used for compliance auditing and security reviews. Each entry in the audit logs is a transaction on the blockchain, making it easy to track the history of changes and access to the system.

In one embodiment, the data storage 250 may also store smart contracts which encode the terms of service agreements between the digital payment processing service and its users, both merchants and customers. Every change or acceptance of these terms can be tracked and verified. The data storage 250 may also store proof of purchase, such as digital receipts and invoices, on the blockchain. Such confirmation provides an immutable record of transactions that can be used for warranties, returns, and audits. The data storage 250 may also store results from KYC (Know Your Customer), KYB (Know Your Business) and AML (Anti-Money Laundering) checks, which can be hashed and stored on the blockchain to provide a clear audit trail of the verification steps taken for each user without exposing personal identity information directly on-chain.

The user interface 260 may provide the visual and interactive components that users engage with. The user interface 260 may deliver a user-friendly interface for accessing the functionalities of the digital payment processing system 200, including account management, transaction initiation, review of transaction history, and access to support services. User interface examples for both customer and merchant mobile applications and web pages can be found in the attached appendix.

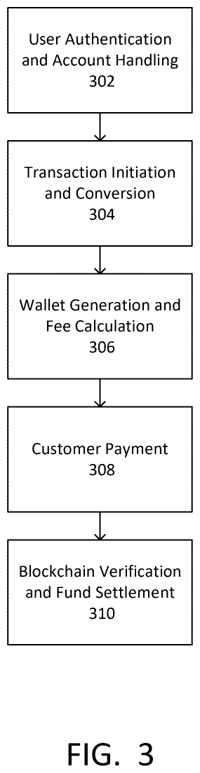

FIG. 3 illustrates a process for completing a commercial transaction by converting fiat currency into cryptocurrency, then converting that cryptocurrency back into fiat currency. Generally, a user device may, via a software application, convert fiat currency (e.g., USD) to cryptocurrency for the purpose of completing a commercial transaction. Once the software application has converted the fiat currency into cryptocurrency, a settlement entity (e.g., a settlement bank) which has been pre-loaded with enough fiat currency to complete any number of transactions, may be notified of the commercial transaction and the corresponding conversion, and submit an amount fiat currency to the merchant's bank to satisfy the commercial transaction. Meanwhile, the cryptocurrency may be sent to a cryptocurrency broker to convert the cryptocurrency back into fiat currency (e.g., by selling the cryptocurrency on the blockchain). Once the cryptocurrency broker converts the cryptocurrency back into fiat currency, the broker may send the fiat currency to the settlement bank to replace the funds that were originally sent by the settlement bank to the merchant bank. Thus, the merchant bank may receive enough fiat currency to satisfy the commercial transaction even before the cryptocurrency is fully converted back into fiat currency.

A user is authenticated 302 and their account is registered within the software application. This step may involve secure login methods such as receiving from the user one or more biometric identification like fingerprint or facial recognition, PIN codes, or traditional password based authentication during registration. The user may also be prompted to input basic profile information such as their name, e-mail, or phone number and may be required to link external fiat-based accounts like debit or credit cards, ensuring that the user has accessible sources of funds which the application can later draw from to purchase cryptocurrency during a transaction.

Based on a commercial transaction between the user and a merchant, a conversion of fiat currency into cryptocurrency may be initiated 304. The merchant, having calculated the total payment due for a commercial transaction (e.g., $50.00 in U.S. dollars) generates a payment request which may prompt the user to open the software application enabled to convert the user's fiat currency into cryptocurrency. In some example embodiments, the payment request is encoded in a QR code. When the user scans this QR code (e.g., via a camera or scanner on a user device), a software application on a user device is prompted to open and retrieve the payment details of the commercial transaction (e.g., merchant details, total payment, and itemization). The software application may prompt the user to select a cryptocurrency they desire to use to complete the transaction. The software application may determine how much of the cryptocurrency is required to match the fiat value of the transaction based on current exchange rates. If needed, the software application may pull funds from the user-linked account to purchase the necessary amount of cryptocurrency to complete the commercial transaction.

Once the user selects the cryptocurrency and confirms the conversion, the software application creates 306 a transaction-specific wallet address. This wallet address serves as a temporary holding account to isolate and track the exact cryptocurrency funds associated with the individual commercial transaction. At the same time, the software application calculates and applies any applicable conversion or transaction fees associated with converting the user's fiat currency into cryptocurrency. Once this conversion is complete, the software application may transmit the cryptocurrency to a dedicated cryptocurrency broker or designated wallet.

Even before the broker sells cryptocurrency on the blockchain, a settlement bank may receive a notification from the software application (or some associated cloud platform between the software application and the settlement bank) to immediately pay 308 the merchant the full amount of the commercial transaction in fiat currency. Thus, the settlement bank ensures that the merchant receives enough fiat currency to satisfy the commercial transaction without waiting for any blockchain confirmations or market transactions. Meanwhile, the cryptocurrency broker performs the conversion of the cryptocurrency into fiat currency. That is, the broker receives the cryptocurrency from the software application, then initiates the process of selling the cryptocurrency on the blockchain to convert it back into fiat currency. Once the cryptocurrency has been successfully sold, the resulting fiat currency is transferred 310 to the settlement bank, thereby replenishing the amount that was initially used to pay the merchant. Thus, the system ensures that both parties, the user and the merchant, have a seamless experience while the complexities of crypto conversion and liquidity are handled behind the scenes.

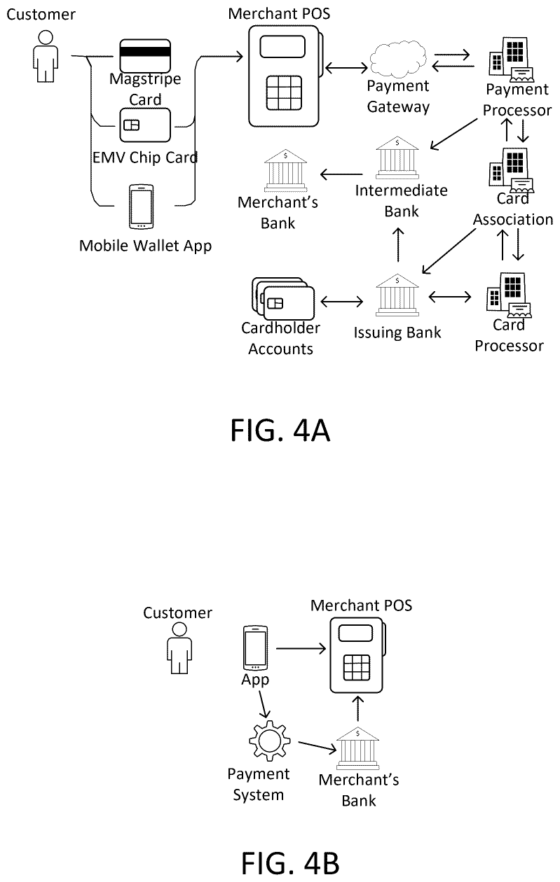

To illustrate the efficiency and privacy improvements offered by the present embodiments, FIGS. 4A and 4B illustrate the differences between conventional banking systems and the present embodiments. FIG. 4A illustrates a conventional commercial transaction which involves a lengthy chain of intermediaries and several steps before a transaction is fully processed and settled. In this traditional model, a customer initiates a payment by presenting a physical card or a digital payment app at the merchant's point of sale terminal. The point of sale device reads payment information such as a magnetic stripe data or a tokenized digital signature, which is sent to a payment gateway and then routed to a payment processor. From there, the transaction is passed through a card association or network like Visa or MasterCard, which identifies the appropriate issuing bank and represents the request accordingly. The issuing bank evaluates the transaction using internal logic and risk models, returning an authorization or denial through the same network of intermediaries. Once the transaction is authorized, the settlement phase begins. The point of sale device sends settlement instructions back to the processor, which again relays the request through the card association. The issuing bank then transfers the purchase amount to the acquiring bank (often the payment processor's bank) which eventually deposits the funds into the merchant's account. This process, although standardized, may take up to two business days to complete. Meanwhile, the issuing bank updates the customer's account with a pending or posted charge. The acquiring bank also deducts processing fees before transferring the net amount to the merchant, and the entire transaction leaves a trail of data across multiple institutions, increasing the operational load and potential for delay or error.

In contrast, FIG. 4B depicts the streamlined cryptocurrency-to-fiat transaction system introduced in the current regime. The model illustrated in FIG. 4B is designed to reduce intermediary layers and accelerate both the payment and settlement process, rather than relying on a web of financial institutions, card networks, and multi-stage authorizations. The system uses a software application that facilitates direct cryptocurrency payments from the user. Once the user scans a QR code and selects a cryptocurrency, the application instantly determines the conversion rate, deducts the equivalent amount of cryptocurrency along with any applicable fees, and transfers a pre-funded settlement to immediately pay the merchant in fiat currency. This ensures merchants are not exposed to cryptocurrency volatility and are paid immediately. As discussed elsewhere herein, in some embodiments, the only post-transaction step required is the broker's role in selling the received cryptocurrency and replenishing the settlement banks reserves. This decouples the merchant's experience from the back end complexities of cryptocurrency markets, while significantly reducing transaction time, cost and friction compared to traditional models. By removing the card association, issuing bank, and acquiring bank from the transaction process, this new architecture represents a leaner, more efficient alternative for commercial payments, particularly as digital assets become more mainstream.

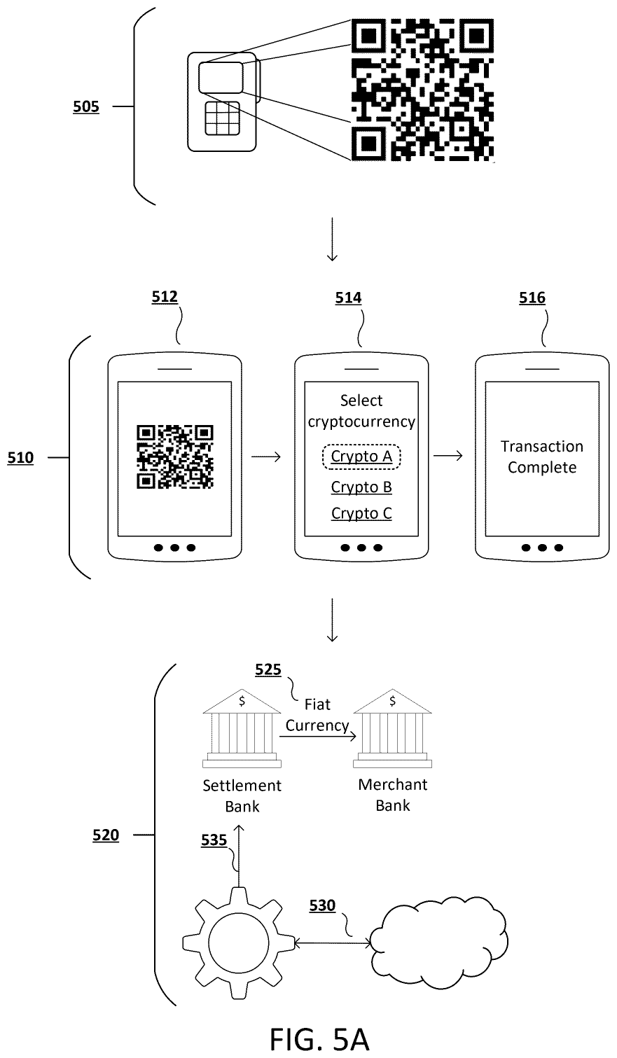

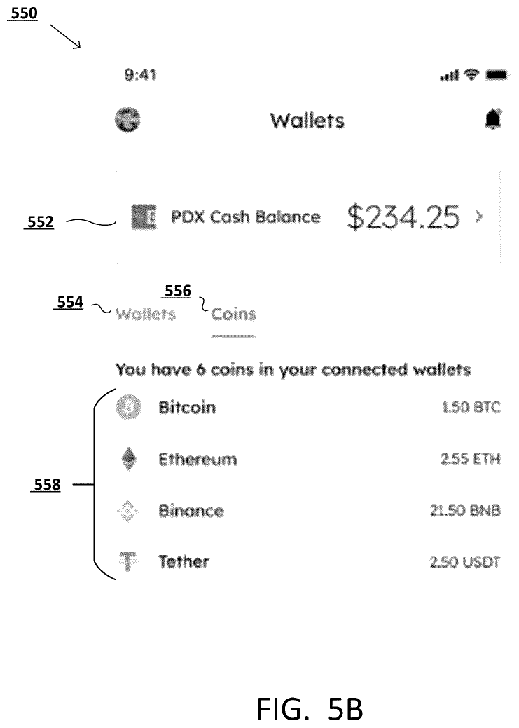

FIG. 5A illustrates how a merchant initiates 505 commercial transaction by displaying a QR code via a point of service device. This QR code contains transaction specific information such as the amount owed in fiat currency, the merchant's unique identifier, and potentially a session token. The QR code may serve as a dynamic gateway that when scanned, launches a software application on the user device specifically designed to handle the cryptocurrency to fiat conversions in real-time. In a series of actions 510, the user device may scan 512 the QR code which prompts the user device to launch 514 the software application. Within the application, the user is presented with a selection of cryptocurrencies, such as cryptocurrency A, cryptocurrency B, and cryptocurrency C from which to complete the commercial transaction. Upon selecting their preferred cryptocurrency and authorizing the transaction, the user may prompt the application to calculate the required amount of cryptocurrency equivalent to the fiat value and confirm the user's intent to proceed. From the user's perspective, the transaction is confirmed and completed 516, providing a seamless and intuitive experience without requiring the user to worry about blockchain mechanics or currency conversion logistics. Meanwhile, in the series of actions 520, the settlement bank may send 525 the fiat currency to the merchant bank, effectively completing the commercial transaction from the merchant's point of view. This pre-funding mechanism eliminates any waiting period for the merchant and guarantees that they are paid in fiat currency regardless of when or how the cryptocurrency is actually converted. It also abstracts away any market volatility or blockchain related timing issues that could otherwise complicate settlement. Meanwhile, the cryptocurrency broker may interact 530 with the blockchain to sell the received cryptocurrency from the software application. Once the cryptocurrency has been successfully converted to fiat currency, the broker transfers 535 the equivalent funds to the settlement bank, replenishing the amount that was originally paid out to the merchant. Thus, the process illustrated in FIG. 5A ensures that while the user pays with cryptocurrency, the merchant receives fiat instantly and the complexities of blockchain interaction and conversion are handled efficiently in the background.

FIG. 5B illustrates a graphical user interface 550 which may, in example embodiments, be presented on a display of a user device as discussed herein. The graphical user interface 550 may include various graphical elements which indicate various information regarding the user's available fiat currency and available cryptocurrency. As discussed herein, the graphical user interface 550 may be made available to the user when the user is interfacing with the software application. The user may be interfacing with the software application once the user has scanned a QR code or otherwise opened the software application on a user device. Although only certain graphical elements have been illustrated with reference to FIG. 5B, it is understood that other graphical user interfaces with other graphical elements may be used.

The graphical user interface 550 may include a fiat currency balance 552, such as, without limitation, a cash balance indicating how many USD the user has available in their account. This fiat currency balance 552 may correspond to how many fiat currencies the user (or even third-parties) has transferred from a financial account (e.g., a debit or credit account) into the software application. The graphical user interface 550 may further include user-accessible tabs for cryptocurrency wallets 554 and cryptocurrency coins 556. The user may have one or more cryptocurrency wallets 554, each containing various amounts of cryptocurrency coins 556. In some embodiments, the graphical user interface 550 may allow the user to transfer different cryptocurrency coins 556 to different cryptocurrency wallets 554. Within a single cryptocurrency wallet 554, a list 558 of cryptocurrency coins may indicate which coins are available for completing commercial transactions. As illustrated in FIG. 5B, the user has Bitcoin, Ethereum, Binance, and Tether coins in their wallet. Other embodiments may include other cryptocurrency coins not illustrated herein, as well as a greater or smaller number of cryptocurrency coins than illustrated. Being shown this list 558 of coins, a user may select at least one of the coins from the list 558 to complete a transaction as discussed herein.

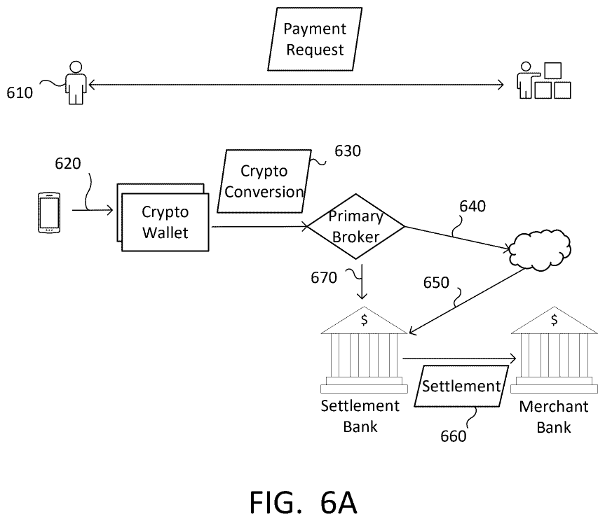

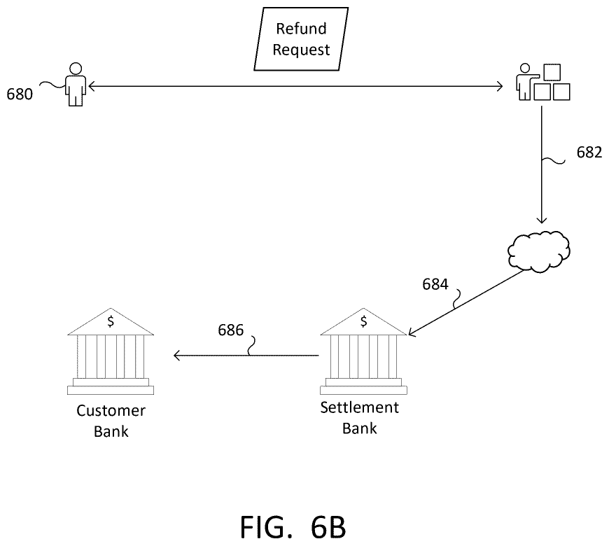

FIG. 6A illustrates a process for completing a commercial transaction by converting fiat currency into cryptocurrency. A user receives 610 a payment request from a merchant as part of a typical commercial transaction, such as purchasing goods or services. This payment request may be delivered through a digital interface, e.g., in the form of a QR code generated by the merchant. The QR code may contain transaction specific information such as the amount owed in fiat currency and merchant identification data and session metadata. When the user scans this QR code using their mobile device, the QR code triggers the launch of a software application designed to facilitate cryptocurrency to fiat payments. In the software application, the user creates 620 a temporary cryptocurrency wallet specifically for this transaction. This wallet is provisioned with the exact amount of cryptocurrency-which has been converted 630 from fiat currency-required to cover the total transaction cost, including any associated fees based on current exchange rates. Once the crypto wallet is funded, the software application transmits the funds to a cryptocurrency broker which may conduct the conversion of these funds into fiat currency. But before completing the sale, the broker sends 640 a message to a connected cloud platform that confirms the transaction details such as the total cryptocurrency amount, applied fees and the equivalent fiat amount needed. Upon receiving this confirmation, the cloud platform communicates 650 directly with the settlement bank, which is pre-integrated into the payment infrastructure. The cloud's instructions prompt the settlement bank to immediately transfer 660 the fiat equivalent to the merchant bank, effectively settling the transaction in real-time. This ensures that the merchant receives payment without delay, regardless of the status of the crypto to fiat conversion. From the merchant's perspective, the transaction is closed and they are paid in traditional fiat currency, insulating them from the volatility and timing uncertainties associated with the cryptocurrency market. Once the broker has completed the process of converting the cryptocurrency into fiat currency, the broker sends 670 the converted funds back to the settlement bank. This final step replenishes the amount that was previously advanced to the merchant's bank.

FIG. 6B illustrates how the system handles a refund request initiated by a user following a completed commercial transaction. A user requests 680 a refund, for example, returning a clothing item purchased from a merchant. This refund request may be initiated through the merchant's digital platform, in person, at a physical location, or through the original software application used for the initial transaction. Once the request is submitted, the merchant evaluates and approves the refund in accordance with their return policy. After approval, the merchant sends 682 a refund instruction to the cloud platform, which acts as a centralized coordination layer in the payment infrastructure. This cloud platform, which has visibility into the transaction history and integration with financial service components, routes 684 the refund request to the settlement bank. The cloud ensures that all necessary metadata, transaction ID, refund amount, and user credentials are included to verify and validate the legitimacy of the refund request. Upon receiving the verified refund request from the cloud platform, the settlement bank initiates 686 a payout of the approved refund amount. Rather than issuing the refund in cryptocurrency, the settlement bank sends the equivalent amount in fiat currency directly to the user's linked bank account. This ensures that the user receives the refund in a familiar and accessible format, even if the original purchase was made in cryptocurrency.

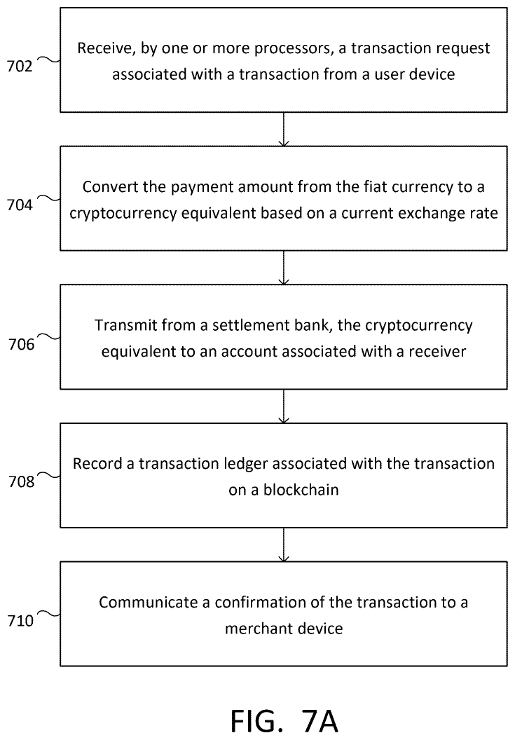

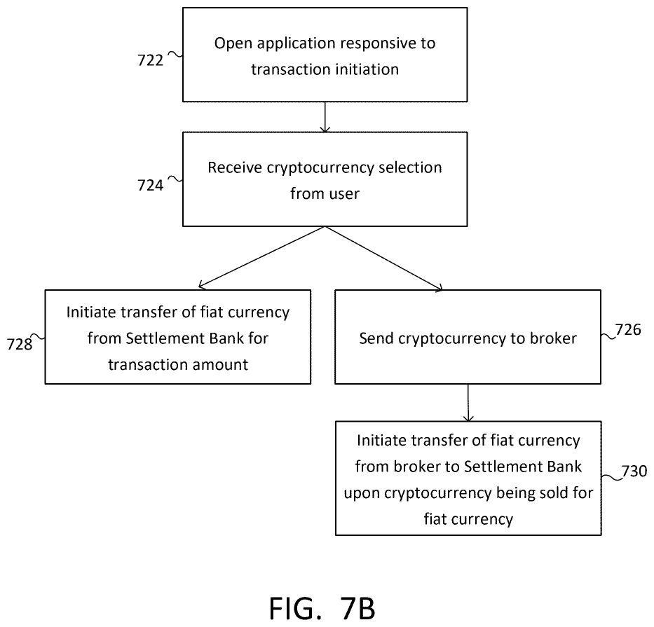

FIG. 7A illustrates a process for completing a commercial transaction by converting fiat currency into cryptocurrency. The system receives 702 a transaction request originating from a user device. This request includes data such as the total payment amount and the corresponding fiat currency type to complete a commercial transaction. This step may be initiated when the user engages with a point of sales system or scans a QR code that communicates the transaction details to the system software application. The system converts 704 the fiat payment amount to its cryptocurrency equivalent using real-time exchange rate data. This conversion ensures that the user pays the exact value of the goods or services in their chosen cryptocurrency, such as Bitcoin or Ethereum. The system also calculates and includes any applicable conversion or service fees at this stage, ensuring the transaction remains financially accurate and transparent. The system transmits 706 the cryptocurrency equivalent to a recipient account associated with a merchant or broker through the settlement bank. This transaction may involve sending crypto directly to a broker wallet or to an intermediary account as part of the back end clearing process. The system reports 708 the transaction details on the blockchain ledger. This action ensures that the transaction is verifiable, immutable, and publicly auditable, which adds a layer of security and transparency to the transaction. The ledger may include data such as transaction amount, timestamp, sender and receiver, and wallet IDs. The system sends 710 a transaction confirmation to the merchant device indicating that the payment has been successfully processed. This confirmation allows the merchant to complete the transaction on their end and marks the transaction as closed from both the user and merchant perspectives.

FIG. 7B outlines a method for completing a cryptocurrency based commercial transaction using a dedicated software application. This process allows a user to initiate and complete a transaction in cryptocurrency while the merchant receives the equivalent amount in fiat currency, creating a seamless user experience backed by robust back end financial infrastructure. A software application may open 722 responsive to a transaction initiation event. This transaction initiation event may be triggered by a number of actions, such as the user scanning the QR code presented by a merchant, receiving a digital payment request, or engaging with a point. The software application may be specifically designed to facilitate the conversion of fiat currency to cryptocurrency for real-time transaction processing. The software application may prompt the user to select a cryptocurrency they wish to use for the transaction. This may include popular options such as Bitcoin, Ethereum, or other supported digital assets. The software application may receive 724 a cryptocurrency selection from the user upon receiving the selection the software. The software application may calculate the fiat-to-cryptocurrency equivalent in real-time based on the latest exchange rates and apply any service or transaction fees required. Once the user confirms their selection, the software application may send 726 the cryptocurrency amount to a designated cryptocurrency broker. This cryptocurrency broker may be responsible for converting the digital assets into fiat currency at market rates. Meanwhile, either the software application itself or a connected cloud platform communicates or initiates 728 the transfer of the fiat currency equivalent to the transaction amount from the settlement bank to the merchant bank, allowing the merchant bank to be paid immediately and in the traditional fiat currency. Meanwhile, the broker may initiate 730 the sale of the received cryptocurrency on the open market. Once the cryptocurrency is successfully converted into fiat currency, the broker transfers the resulting funds to the settlement bank, thereby covering the amount that was previously advanced to the merchant bank. By deferring the replenishment to the broker successful conversion, the system ensures liquidity, efficiency and a smooth user and merchant experience.

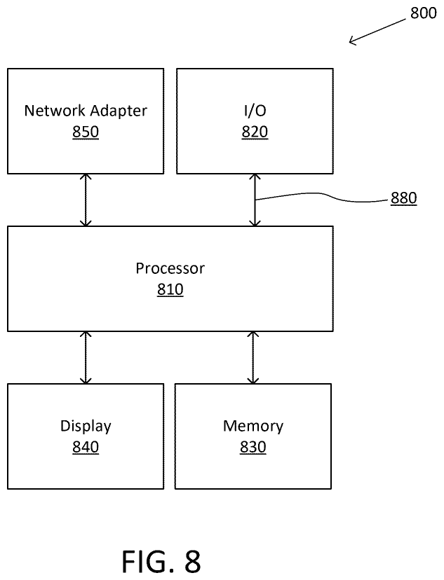

Referring to FIG. 8, the computing system 800 may include a processor 810, I/O devices 820, a memory 830, a display device 840, and/or a network adaptor 850.

The processor 810 may drive the I/O devices 820, the memory system 830, the display device 840, and/or the network adaptor 850 through a bus 880.

The computing system 800 may include a program module for performing: the functions or operations described hereinabove with respect to at least one of the systems of FIGS. 1-7. For example, the program module may include routines, programs, objects, components, logic, data structures, or the like, for performing particular tasks or implementing particular abstract data types. The processor (e.g., 810) of the computing system 800 may execute instructions written in the program module to perform: the functions or operations described hereinabove with respect to at least one of the systems of FIGS. 1-7. The program module may be programmed into the integrated circuits of the processor (e.g., 810). In an exemplary embodiment, the program module may be stored in the memory system (e.g., 830) or in a remote computer system storage media.

The computing system 800 may include a variety of computing system readable media. Such media may be any available media that is accessible by the computer system (e.g., 800), and it may include both volatile and non-volatile media, removable and non-removable media.

The memory system (e.g., 830) can include computer system readable media in the form of volatile memory, such as RAM and/or cache memory or others. The computer system (e.g., 800) may further include other removable/non-removable, volatile/non-volatile computer system storage media.

The computer system (e.g., 800) may communicate with one or more devices using the network adapter (e.g., 850). The network adapter may support wired communications based on Internet, local area network (LAN), wide area network (WAN), or the like, or wireless communications based on code division multiple access (CDMA), global system for mobile communication (GSM), wideband CDMA, CDMA-2000, time division multiple access (TDMA), long term evolution (LTE), wireless LAN, Bluetooth, Zig Bee, or the like.

Exemplary embodiments of the present disclosure may include a system, a method, and/or a non-transitory computer readable storage medium. The non-transitory computer readable storage medium (e.g., the memory system 830) has computer readable program instructions thereon for causing a processor to carry out aspects of the present disclosure.

The computer readable storage medium can be a tangible device that can retain and store instructions for use by an instruction execution device. The computer readable storage medium may be, for example, but not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EEPROM or Flash memory), a static random access memory (SRAM), a portable compact disc read-only memory (CD-ROM), a digital versatile disk (DVD), a memory stick, a floppy disk, or the like, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to the computing system 800 from the computer readable storage medium or to an external computer or external storage device via a network. The network may include copper transmission cables, optical transmission fibers, wireless transmission, routers, firewalls, switches, gateway computers and/or edge servers. A network adapter card (e.g., 850) or network interface in each computing/processing device receives computer readable program instructions from the network and forwards the computer readable program instructions for storage in a computer readable storage medium within the computing system.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the computing system (e.g., 800) through any type of network, including a LAN or a WAN, or the connection may be made to an external computer (for example, through the Internet using an Internet Service Provider). In an exemplary embodiment, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Various embodiments can be described by the following clauses:
1. A system comprising one or more processors to:
   receive, by one or more processors, a transaction request associated with a transaction from a user device, the transaction request indicating a payment amount in a fiat currency;
   convert the payment amount from the fiat currency to a cryptocurrency equivalent based on a current exchange rate;
   transmit, from a settlement bank, the cryptocurrency equivalent to an account associated with a receiver;
   record a transaction ledger associated with the transaction on a blockchain; and
   communicate a confirmation of the transaction to a merchant device.
2. The system of clause 1, wherein the transaction request received from the user device includes a quick response (QR) code scan from the user device to facilitate the transaction at a point of sale.
3. The system of clause 1, wherein the one or more processors are further to verify an identity associated with a user that initiated the transaction request using a decentralized identity management system before initiating the transaction.
4. The system of clause 1, wherein the one or more processors are further to conduct an anti-fraud analysis using historical transaction data to ensure a legitimacy of the transaction prior to completing the settlement.
5. The system of clause 1, wherein the one or more processors are further to conduct a refund process associated with the transaction responsive to receiving a refund request.
6. A system comprising one or more processors to:
   responsive to a transaction request between a user and a merchant for a fiat currency, providing one or more cryptocurrencies available for selection by a user on a user interface;
   converting, based at least on a selected cryptocurrency, a fiat currency amount into a cryptocurrency amount, the fiat currency amount to satisfy a transaction request;
   generating a transaction-specific cryptocurrency wallet to hold the cryptocurrency amount;
   transmitting the cryptocurrency amount from the transaction-specific cryptocurrency wallet to a cryptocurrency broker;
   causing a transfer of funds from a settlement bank to a merchant bank, the transfer of funds comprising an equivalent fiat currency amount to satisfy the transaction request; and
   causing a converted fiat currency amount from the cryptocurrency broker to be transmitted to the settlement bank.
7. The system of clause 6, wherein converting the fiat currency comprises generating one or more transaction fees further comprising one or more exchange rate fees and broker fees.
8. The system of clause 6, wherein the one or more processors are further to archive or discard the transaction-specific cryptocurrency wallet upon completion of the transaction request.
9. The system of clause 6, wherein the one or more processors are further to verify that the user and the merchant are registered to complete the transaction request.
10. The system of clause 6, wherein the one or more processors are further to authenticate the user with at least one of a PIN, password, or biometric.
11. The system of clause 6, wherein the one or more processors are further to receive, from a QR code, transaction details comprising at least one of a merchant ID, transaction amount, and itemization.
12. The system of clause 6, wherein the one or more processors are further to generate a refund for the transaction request by causing the settlement bank to transmit a refund amount to a user account.
13. The system of clause 6, wherein the transaction request is initiated by a quick response (QR) code scanned from a user device associated with the user.
14. A processor comprising one or more logical units to:
   prior to a cryptocurrency broker converting a cryptocurrency amount to a converted fiat currency amount, cause a settlement entity to transmit an equivalent fiat currency amount to a merchant entity to satisfy a transaction request; and
   cause the cryptocurrency broker to transmit the converted fiat currency amount to the settlement entity.
15. The processor of clause 14, wherein the transaction request is initiated by a quick response (QR) code.
16. The processor of clause 14, wherein the one or more logical units are further to generate a list of one or more available cryptocurrencies and one or more corresponding exchange rates for converting the transaction amount.
17. The processor of clause 14, wherein the one or more logical units are further to open a software application with a user interface responsive to a user device scanning a quick response (QR) code.
18. The processor of clause 17, wherein the one or more logical units are further to receive, from the QR code, transaction details comprising at least one of a merchant ID, transaction amount, and itemization.
19. The processor of clause 14, wherein the one or more logical units are further to provide, via a user interface, a user with one or more cryptocurrency wallets comprising one or more available cryptocurrencies.
20. The processor of clause 14, wherein the one or more logical units are further to generate a refund for the transaction request by causing the settlement entity to transmit a refund amount to a user account.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various illustrative embodiments of the present invention provide for digital payment processing that integrates cryptocurrency transactions with traditional banking systems through the use of, for example, blockchain technology in a streamlined digital payment process. As an example, a digital payment processing system may integrate cryptocurrency with exchanges and banking systems via APIs (Application Programming Interfaces). Such integration allows for the determination and use of real-time exchange rates, as well as almost immediate transfer of funds between cryptocurrency and fiat (traditional) or other such currency. By automating the exchange process and connecting directly to financial institutions for instant fiat settlement, such approaches can effectively avoid the usual delays of blockchain (or other distributed ledger-based) confirmations. Such a system may also utilize other technologies for facilitating a faster transaction process, such as off-chain solutions (e.g., transactions that occur outside of the blockchain) or layer-2 scaling solutions, utilizing faster consensus mechanisms.

Additionally, such an approach may use blockchain technology (e.g., Polygon's blockchain technology) to not only streamline the transaction process but also enhance user experience by reducing latency and improving scalability. For example, using immutable identity verification mechanisms, user privacy can be bolstered, and robust control provided over personal data, which can be enabled by the secure and decentralized nature of a blockchain. Such an approach may also use smart contracts to automate and enforce agreements with absolute transparency and tamper-proof execution, which can be is achieved at least in part through the ability of a blockchain or distributed ledger to execute complex algorithms and store data securely. Furthermore, such an approach may support streamlined management of tokenized assets through the use of cryptographic tokens for secure asset handling, which can help to simplify transactions while ensuring their integrity. Functionalities associated with such a digital payment processing system are discussed in greater detail below.

Variations of this and other such functionality can be used as well within the scope of the various embodiments as would be apparent to one of ordinary skill in the art in light of the teachings and suggestions contained herein.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising one or more processors to:
receive, by one or more processors, a transaction request associated with a transaction from a user device, the transaction request indicating a payment amount in a fiat currency;
convert the payment amount from the fiat currency to a cryptocurrency equivalent based on a current exchange rate;
transmit, from a settlement bank, the cryptocurrency equivalent to an account associated with a receiver;
record a transaction ledger associated with the transaction on a blockchain; and
communicate a confirmation of the transaction to a merchant device.

2. The system of claim 1, wherein the transaction request received from the user device includes a quick response (QR) code scan from the user device to facilitate the transaction at a point of sale.

3. The system of claim 1, wherein the one or more processors are further to verify an identity associated with a user that initiated the transaction request using a decentralized identity management system before initiating the transaction.

4. The system of claim 1, wherein the one or more processors are further to conduct an anti-fraud analysis using historical transaction data to ensure a legitimacy of the transaction prior to completing the settlement.

5. The system of claim 1, wherein the one or more processors are further to conduct a refund process associated with the transaction responsive to receiving a refund request.

6. A system comprising one or more processors to:
responsive to a transaction request between a user and a merchant for a fiat currency, providing one or more cryptocurrencies available for selection by a user on a user interface;
converting, based at least on a selected cryptocurrency, a fiat currency amount into a cryptocurrency amount, the fiat currency amount to satisfy a transaction request;
generating a transaction-specific cryptocurrency wallet to hold the cryptocurrency amount;
transmitting the cryptocurrency amount from the transaction-specific cryptocurrency wallet to a cryptocurrency broker;
causing a transfer of funds from a settlement bank to a merchant bank, the transfer of funds comprising an equivalent fiat currency amount to satisfy the transaction request; and
causing a converted fiat currency amount from the cryptocurrency broker to be transmitted to the settlement bank.

7. The system of claim 6, wherein converting the fiat currency comprises generating one or more transaction fees further comprising one or more exchange rate fees and broker fees.

8. The system of claim 6, wherein the one or more processors are further to archive or discard the transaction-specific cryptocurrency wallet upon completion of the transaction request.

9. The system of claim 6, wherein the one or more processors are further to verify that the user and the merchant are registered to complete the transaction request.

10. The system of claim 6, wherein the one or more processors are further to authenticate the user with at least one of a PIN, password, or biometric.

11. The system of claim 6, wherein the one or more processors are further to receive, from a QR code, transaction details comprising at least one of a merchant ID, transaction amount, and itemization.

12. The system of claim 6, wherein the one or more processors are further to generate a refund for the transaction request by causing the settlement bank to transmit a refund amount to a user account.

13. The system of claim 6, wherein the transaction request is initiated by a quick response (QR) code scanned from a user device associated with the user.

14. A processor comprising one or more logical units to:
prior to a cryptocurrency broker converting a cryptocurrency amount to a converted fiat currency amount, cause a settlement entity to transmit an equivalent fiat currency amount to a merchant entity to satisfy a transaction request; and
cause the cryptocurrency broker to transmit the converted fiat currency amount to the settlement entity.

15. The processor of claim 14, wherein the transaction request is initiated by a quick response (QR) code.

16. The processor of claim 14, wherein the one or more logical units are further to generate a list of one or more available cryptocurrencies and one or more corresponding exchange rates for converting the transaction amount.

17. The processor of claim 14, wherein the one or more logical units are further to open a software application with a user interface responsive to a user device scanning a quick response (QR) code.

18. The processor of claim 17, wherein the one or more logical units are further to receive, from the QR code, transaction details comprising at least one of a merchant ID, transaction amount, and itemization.

19. The processor of claim 14, wherein the one or more logical units are further to provide, via a user interface, a user with one or more cryptocurrency wallets comprising one or more available cryptocurrencies.

20. The processor of claim 14, wherein the one or more logical units are further to generate a refund for the transaction request by causing the settlement entity to transmit a refund amount to a user account.
